(19) United States
(12) Patent Application Publication
(10) Pub. No.: US 2014/0083002 A1
(43) Pub. Date: Mar. 27, 2014

(54) GARDEN PLANT PROTECTOR

(71) Applicant: Paul C. McMichael, Round Hill, VA (US)

(72) Inventor: Paul C. McMichael, Round Hill, VA (US)

(21) Appl. No.: 14/091,217

(22) Filed: Nov. 26, 2013

Related U.S. Application Data
(63) Continuation-in-part of application No. 12/662,235, filed on Apr. 7, 2010.

(51) Int. Cl. A01G 13/04; A01G 13/02

(52) U.S. Cl. CPC A01G 13/04; A01G 13/02
USPC 47/31

(57) ABSTRACT

A freestanding foraminous frame is provided for the protection of gardens against deer, varmints, birds, and the like. The frame may include three planar sections, including a top section and a pair of side sections. The three planar sections form a protective coop within. The side sections are attached to the top section and extend downward from the top section and outward away from each other. The frame may be made of criss-crossing metal wire segments allowing gases, liquids, and light to move freely within. A plurality of frames may be placed end to end to extend the length of the protective coop.

### CROSS-REFERENCE TO RELATED APPLICATION

This application is a continuation-in-part of application Ser. No. 12/662,235, filed Apr. 7, 2010.

### BACKGROUND OF THE INVENTION

The present invention relates to a garden plant protector and, more particularly, to at least one freestanding foraminous frame used for protecting gardens.

Gardening is the practice of growing and cultivating plants as part of horticulture. In gardens, ornamental plants are often grown for their flowers, foliage, or overall appearance; useful plants, such as root vegetables, leaf vegetables, fruits, and herbs, are grown for consumption, for use as dyes, or for medicinal or cosmetic use. Gardeners have tried to prevent wildlife from consuming the plants grown in the garden. For example, fences are erected around the garden for preventing wildlife from entering the garden. However, a fence will not prevent all wildlife from entering the garden. Deer in particular have the ability to leap over standard fences and subsequently destroy the garden.

As can be seen, there is a need for a device that may be used to protect a garden from wildlife.

### SUMMARY OF THE INVENTION

In one aspect of the present invention, an apparatus comprises: a freestanding foraminous frame comprising three planar sections comprising a top section, and two side sections attached to the top section, wherein the two side sections extend downward from the top section and outward away from each other, wherein the two side sections comprise a bottom end configured to be placed on a surface and support the freestanding foraminous frame in an upright position; wherein the freestanding foraminous frame forms a protective coop in between the three planar sections, and the freestanding foraminous frame comprises a pair of ends forming side openings leading into the protective coop; wherein a plurality of freestanding foraminous frames is capable of being placed end to end to extend the length of the protective coop formed, and end to end overlapping all three planar sections to extend the length of the protective coop formed.

In another aspect of the present invention, an apparatus comprises: a plurality of identical freestanding foraminous frames formed of criss-crossing metal wire segments, wherein each freestanding foraminous frame comprises three planar sections comprising a top section, and two side sections attached to the top section, wherein the two side sections extend downward from the top section and outward away from each other, wherein the two side sections comprise a bottom end configured to be placed on a surface and support the freestanding foraminous frame in an upright position; wherein each freestanding foraminous frame forms a protective coop in between the three planar sections, and each freestanding foraminous frame comprises a first end and a second end each forming a side opening leading into the protective coop; wherein the plurality of freestanding foraminous frames comprises at least a first freestanding foraminous frame and a second freestanding foraminous frame, wherein all three planar frame sections of the first end of the first freestanding foraminous frame and the second end of the second freestanding foraminous frame are overlapping forming a single protective coop greater in length than the protective coop formed within each separate freestanding foraminous frame.

These and other features, aspects and advantages of the present invention will become better understood with reference to the following drawings, description and claims.

### BRIEF DESCRIPTION OF THE DRAWINGS

FIG. 1 is a perspective view of a single frame of the present invention;

FIG. 2 is a front view of the frame of FIG. 1 showing an end of the frame and a closure attached to the end;

FIG. 3 is an exploded view of a plurality of frames of the present invention; and

FIG. 4 is a perspective view of a first frame and a second frame, with the ends of the first frame and second frame overlapping.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a freestanding foraminous frame for the protection of gardens against deer, varmints, birds, and the like. The frame may include three planar sections, including a top section and a pair of side sections. The three planar sections form a protective coop within. The side sections are attached to the top section and extend downward from the top section and outward away from each other. The frame may be made of criss-crossing metal wire segments allowing gases, liquids, and light to move freely within. A plurality of frames may be placed end to end to extend the length of the protective coop.

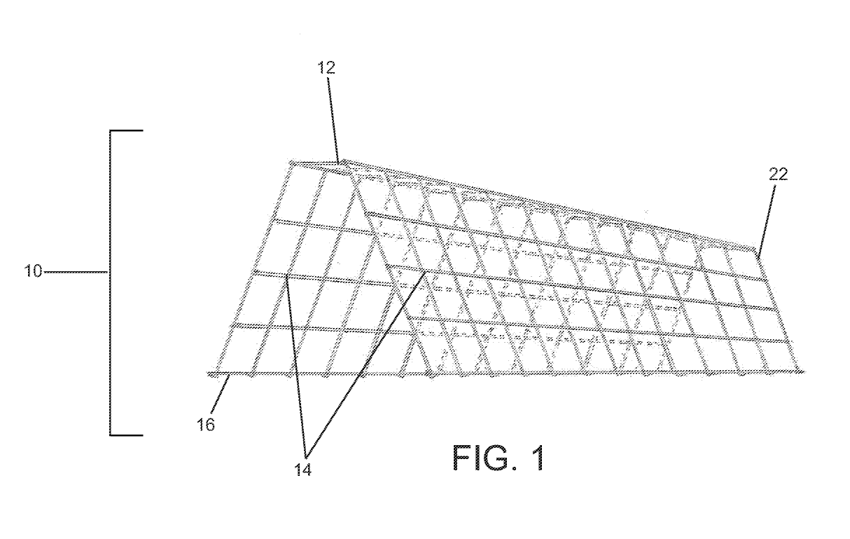

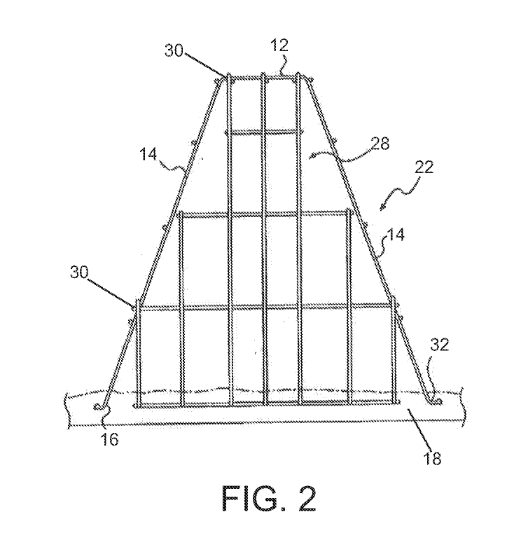

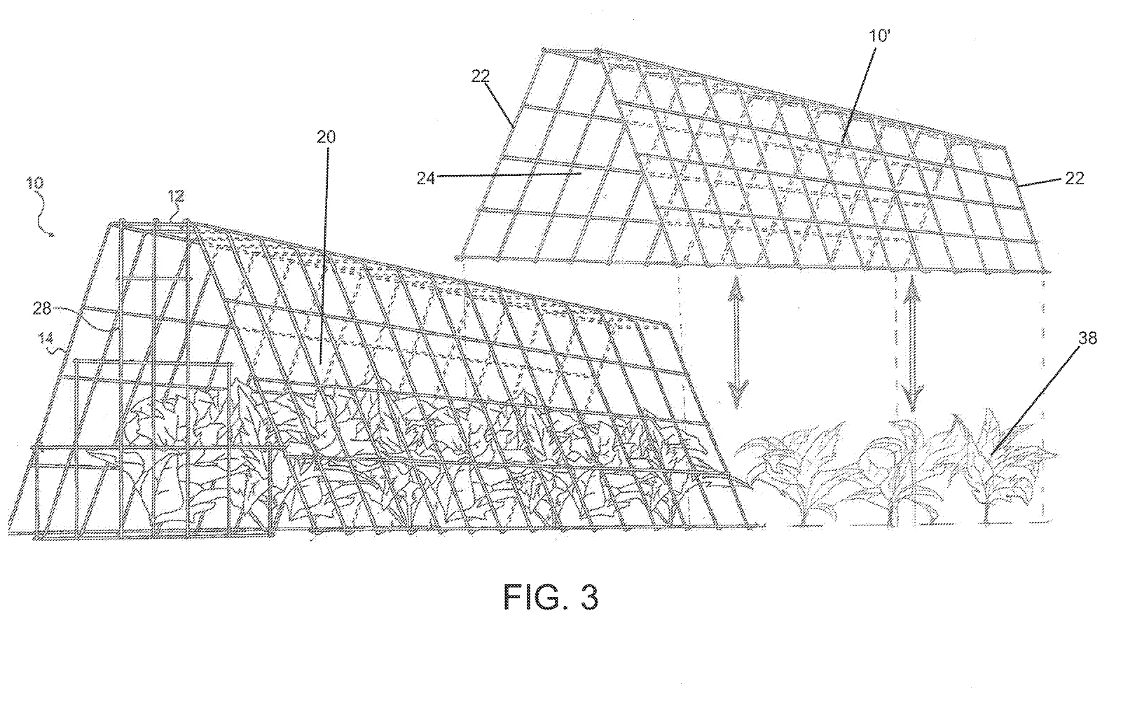

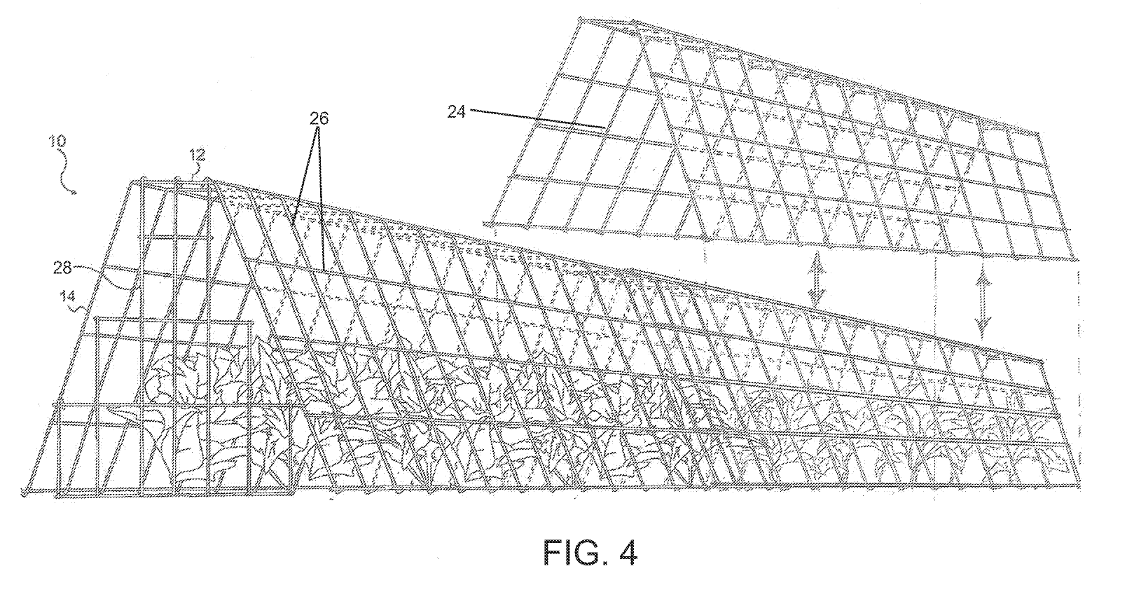

Referring to FIGS. 1 through 4, the present invention includes a freestanding foraminous frame 10. The frame 10 may include three planar sections. The planar sections include a top section 12 and a pair of side sections 14. The side sections 14 are attached to the top section 12 and extend downward from the top section 12 and outward away from each other. The top section 12 and the two side sections 14 may be substantially flat. The side sections 14 may include a bottom section 16. The bottom section 16 may be placed on a surface 18 a support the frame 10 in an upright position. In certain embodiments, the bottom section 16 may further include integral outwardly extending flanges 32 to further support the frame 10 on the surface 18.

The frame 10 of the present invention may form a protective coop 20 in between the three planar sections. The frame 10 may include a pair of ends 22, such as a first end and a second end, which form side openings 24. The side openings 24 may lead into the protective coop 20. The frame 10 of the present invention may be placed over a garden row 38. The garden row 38 may be within the protective coop 20 which may prevent wildlife, such as deer, from eating the plants within the garden row 38. Gases, liquids, and light may move freely through the foraminous frame 10 to allow the garden row 38 access to water, light and air while within the protective coop 20.

In certain embodiments, the present invention may include a plurality of freestanding foraminous frames 10, which may be identical. The plurality of frames 10 may include two, three, four or more frames. For example, the plurality of frames 10 may include at least a first frame 10 and a second frame 10′. The plurality of freestanding foraminous frames 10 are capable of being placed end to end to extend the length of the protective coop 20 formed, and end to end overlapping all three planar sections to extend the length of the protective coop 20 formed. For example, all three planar frame sections of the first end 22 of the first freestanding foraminous frame 10 and all three planar frame sections of the second end 22 of the second freestanding foraminous frame 10′ may overlap, forming a single protective coop 20 greater in length than the protective coop formed within each separate freestanding foraminous frame 10. When the plurality of frames 10 are placed end to end and end to end overlapping, the top sections 12 of the plurality of frames 10 may remain substantially parallel with the surface 18 that the frame 10 is placed on when in the upright position.

In certain embodiments, the present invention is made of criss-crossing metal wire segments 26. The metal wire 26 may be galvanized and may be a 14 gauge metal. The wire segments 26 may be welded or fused together to form the frame 10. The wire segments 26 may include a plurality of horizontal wire segments 26 and a plurality of vertical wire segments 26. The plurality of horizontal wire segments 26 and the plurality of vertical wire segments 26 may intersect and connect at perpendicular angles to form a plurality of rectangular cavities in between.

The present invention may further include closures 28 to cover up the side openings 24 and prevent smaller animals from entering the protective coop 20. The closures 28 may be removeably attachable to the ends 22 of the frame 10. In certain embodiments, when a plurality of frames 10 are placed end to end or end to end overlapping, the plurality of frames 10 combined form two openings 24, a first opening 24 and a second opening 24, that lead into the single protective coop 20. The first opening 24 and the second opening 24 may be located at the ends 22 of the outer frames 10. The closures 28 may be attached to the first opening 24 and the second opening 24 to further enclose the protective coop 20 formed within the plurality of frames 10.

In certain embodiments, the closures 28 may be secured to the ends 22 of the frames by ties, clips, or the like. However, in certain embodiments, the closures 28 may further include a plurality of wire protrusions 30 permanently fastened to and extending from outer edges of the closures 28. The plurality of wire protrusions 30 may warp around the edges of the ends 22 of the frame 10, which secures the closures 28 to the ends of the frame 10 and covers up the side openings 24.

As mentioned above, the frames 10 of the present invention may be placed over garden rows 38 to protect a user's gardens from animals, such as deer, groundhogs, rabbits, birds, and the like. In alternative embodiments, the present invention may be used to protect the garden rows 38 from insects. A netting may be placed over the frames 10 and thereby cover the rectangular cavities. The netting may include small enough openings to prevent insects from entering the protective coop 20 and destroying the plants within. Further, to prevent plants from freezing, an insulated covering may be placed over the frames 10 during a cold night. This may allow the plants to survive during unseasonable weather.

The present invention may be conveniently packed and transported. A plurality of frames 10 may be stacked on top of one another. For example, ten frames 10 may be stacked on top of one another for shipping. The ten frames 10 may be compressed and connected together at the bottom end 16 by a tie, clip or the like. The compressed ten frames 10 may then be placed within a box and shipped. Further, since the closures 28 are removeably attachable, the closures 28 may be removed and placed within the box for shipping.

It should be understood, of course, that the foregoing relates to exemplary embodiments of the invention and that modifications may be made without departing from the spirit and scope of the invention as set forth in the following claims.

What is claimed is:

1. An apparatus comprising:
a freestanding foraminous frame comprising three planar sections comprising a top section, and two side sections attached to the top section, wherein the two side sections extend downward from the top section and outward away from each other, wherein the two side sections comprise a bottom end configured to be placed on a surface and support the freestanding foraminous frame in an upright position;
wherein the freestanding foraminous frame forms a protective coop in between the three planar sections, and the freestanding foraminous frame comprises a pair of ends forming side openings leading into the protective coop;
wherein a plurality of freestanding foraminous frames is capable of being placed end to end to extend the length of the protective coop formed, and end to end overlapping all three planar sections to extend the length of the protective coop formed.

2. The apparatus of claim 1, wherein the plurality of freestanding foraminous frames comprises at least a first freestanding foraminous frame and a second freestanding foraminous frame, wherein the first freestanding foraminous frame and the second freestanding foraminous frame are end to end overlapping all three planar sections to extend the length of the protective coop formed, wherein the top sections of the first and second freestanding foraminous frame are substantially parallel to the surface when the frame is placed on the surface in the upright position.

3. The apparatus of claim 1, wherein the freestanding foraminous frame is formed of criss-crossing metal wire segments.

4. The apparatus of claim 3, wherein the metal wire is 14 gauge metal.

5. The apparatus of claim 3, wherein the metal wire segments comprise a plurality of horizontal wire segments, and a plurality of vertical wire segments, wherein the plurality of horizontal wire segments and the plurality of vertical wire segments intersect and connect at perpendicular angles to form a plurality of rectangular cavities.

6. The apparatus of claim 1, further comprising a plurality of closures removeably attachable to the ends of the freestanding foraminous frame, wherein the plurality of closures covers the side openings.

7. The apparatus of claim 6, wherein the plurality of freestanding foraminous frames placed end to end comprises at least a first freestanding foraminous frame at a first end of the protective coop and a second freestanding foraminous frame at a second end of the protective coop, wherein the first frame forms a first opening leading into the protective coop and a second frame forms a second opening leading into the protective coop.

8. The apparatus of claim 7, wherein the plurality of closures comprises at least a first closure and a second closure, wherein the first closure covers the first opening and the second closure covers the second opening.

9. The apparatus of claim 6, wherein the closures comprise a plurality of wire protrusions permanently fastened to and extending from outer edges of the closures, wherein the plurality of wire protrusions are configured to wrap around the ends of the freestanding foraminous frame, thereby securing the closure to the freestanding foraminous frame.

10. The apparatus of claim 1, further comprising integral outwardly extending flanges along the bottom ends of the two side sections.

11. The apparatus of claim 1, wherein the plurality of freestanding foraminous frames is capable of being stacked on top of one another.

12. The apparatus of claim 1, further comprising a netting placed over the freestanding foraminous frame.

13. The apparatus of claim 1, further comprising an insulating covering placed over the freestanding foraminous frame.

14. The apparatus of claim 1, wherein the top section and the two side sections are flat.

15. An apparatus comprising:
a plurality of identical freestanding foraminous frames formed of criss-crossing metal wire segments, wherein each freestanding foraminous frame comprises three planar sections comprising a top section, and two side sections attached to the top section, wherein the two side sections extend downward from the top section and outward away from each other, wherein the two side sections comprise a bottom end configured to be placed on a surface and support the freestanding foraminous frame in an upright position;
wherein each freestanding foraminous frame forms a protective coop in between the three planar sections, and each freestanding foraminous frame comprises a first end and a second end each forming a side opening leading into the protective coop;
wherein the plurality of freestanding foraminous frames comprises at least a first freestanding foraminous frame and a second freestanding foraminous frame, wherein all three planar frame sections of the first end of the first freestanding foraminous frame and the second end of the second freestanding foraminous frame are overlapping forming a single protective coop greater in length than the protective coop formed within each separate freestanding foraminous frame.
